(19) United States
(12) Patent Application Publication
(10) Pub. No.: US 2026/0089421 A1
(43) Pub. Date: Mar. 26, 2026

(54) MICROPHONE MOUNTED SHIELD DEVICE

(71) Applicant: Kenneth Williams, Olympia Fields, IL (US)

(72) Inventor: Kenneth Williams, Olympia Fields, IL (US)

(21) Appl. No.: 18/894,178

(22) Filed: Sep. 24, 2024

(51) Int. Cl. H04R 1/08

(52) U.S. Cl. CPC H04R 1/083

(57) ABSTRACT

A microphone mounted shield device for concealing a user's mouth when the user is wearing a headset includes a shield which is mountable to a microphone arm of a headset. The shield is positioned in front of a user's mouth when the user is wearing the headset. The shield is comprised of an opaque material to inhibit light from passing through the shield thereby inhibiting an observer from being capable of perceiving the user's mouth when the user is speaking into a microphone which is mounted to the microphone arm for enhancing privacy with respect to the words the user is speaking. A strap is removably mountable to the shield thereby enabling the strap to be extended around the microphone arm of the headset for securing the shield to the microphone arm.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shield devices and more particularly pertains to a new shield device for concealing a user's mouth when the user is wearing a headset. The device includes a shield that is comprised of an opaque material and a plurality of slots that each extend through the shield. The device includes a strap that is extendable through a respective pair of the slots thereby enabling the strap to be secured around a microphone arm of the headset for mounting the shield to the microphone arm. The device includes a first coupler and a second coupler each attached to the strap and which are matable to each other to form the strap into a closed loop for securing the strap around the microphone arm. In this way the shield conceals the user's mouth from an observer when the user is wearing the headset.

### (2) Description of Related Art Including Information Disclosed Under 37 CFR 1.97 and 1.98

The prior art relates to shield devices including a variety of microphone shield devices that each at least includes a shield which is structured to have an ovoid shape and which is mountable to a microphone arm of a headset thereby concealing a user's mouth when the user is wearing the headset and a mouth shield device that is structured to have an approximately triangular shape which is mountable to a microphone arm of a headset thereby concealing a user's mouth when the user is wearing the headset. In no instance does the prior art disclose a microphone shield device that includes a shield which is structured to have a rectangular shape that is mountable to a microphone arm of a headset for concealing a user's mouth when the user is wearing a headset.

### BRIEF SUMMARY OF THE INVENTION

An embodiment of the disclosure meets the needs presented above by generally comprising a shield which is mountable to a microphone arm of a headset. The shield is positioned in front of a user's mouth when the user is wearing the headset. The shield is comprised of an opaque material to inhibit light from passing through the shield thereby inhibiting an observer from being capable of perceiving the user's mouth when the user is speaking into a microphone which is mounted to the microphone arm for enhancing privacy with respect to the words the user is speaking. A strap is removably mountable to the shield thereby enabling the strap to be extended around the microphone arm of the headset for securing the shield to the microphone arm.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a microphone mounted shield device according to an embodiment of the disclosure.

FIG. 2 is a front perspective view of an embodiment of the disclosure.

FIG. 3 is an exploded back view of an embodiment of the disclosure.

FIG. 4 is a perspective view of an embodiment of the disclosure showing a shield and a headset.

FIG. 5 is a perspective in-use view of an embodiment of the disclosure showing a shield mounted to a headset that is being worn by a user.

FIG. 6 is a perspective in-use view of an embodiment of the disclosure showing a user wearing a headset on a playing field.

### DETAILED DESCRIPTION OF THE INVENTION

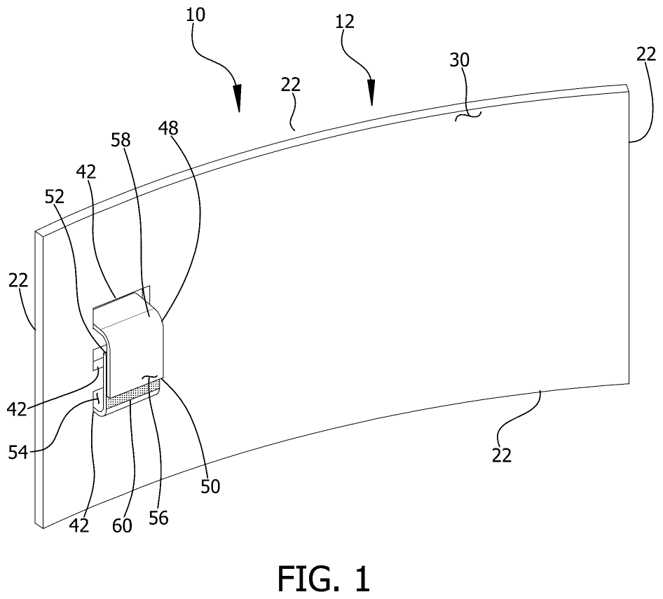

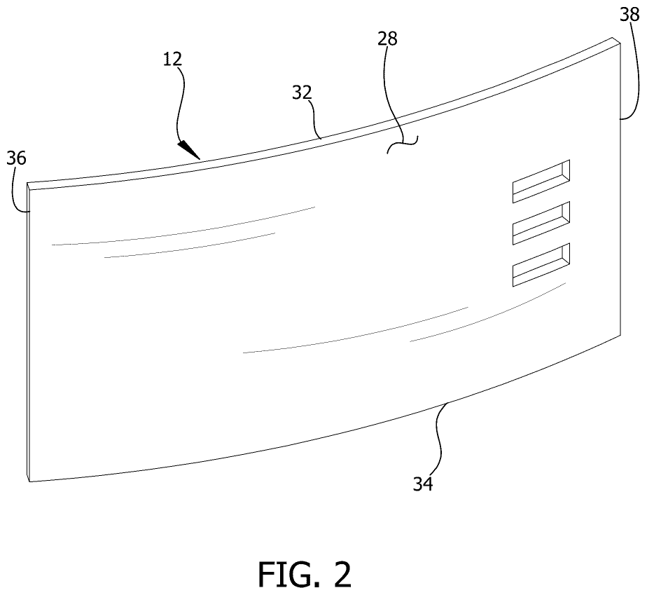

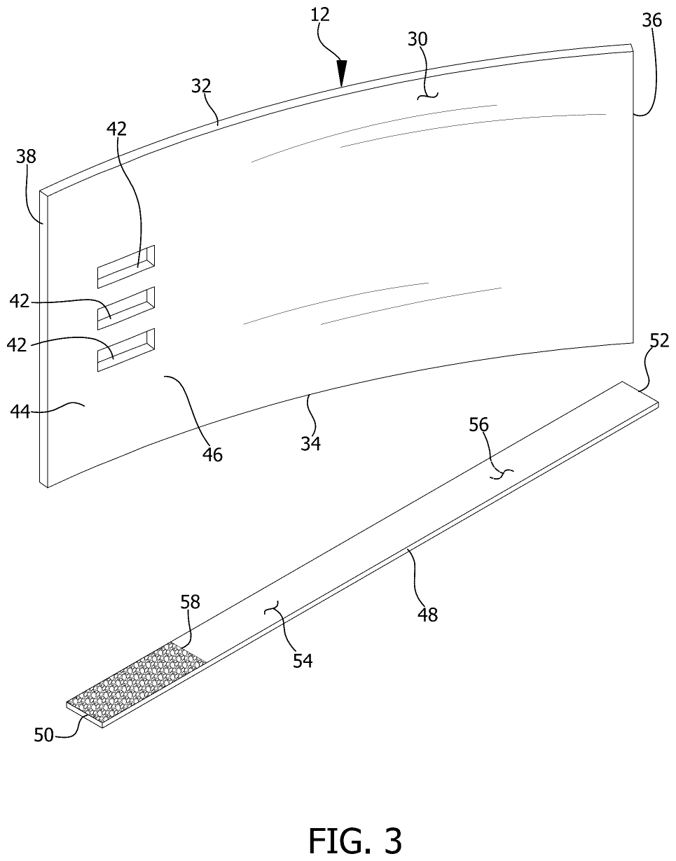

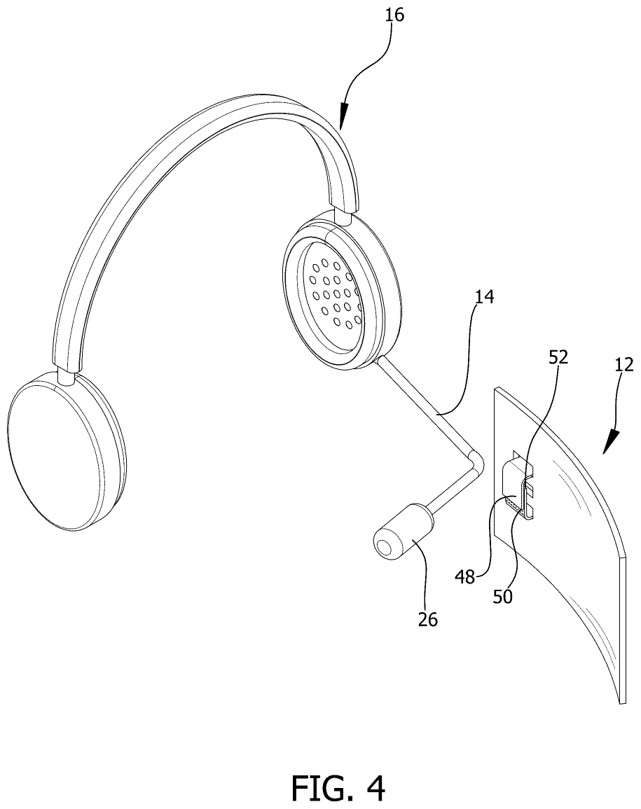

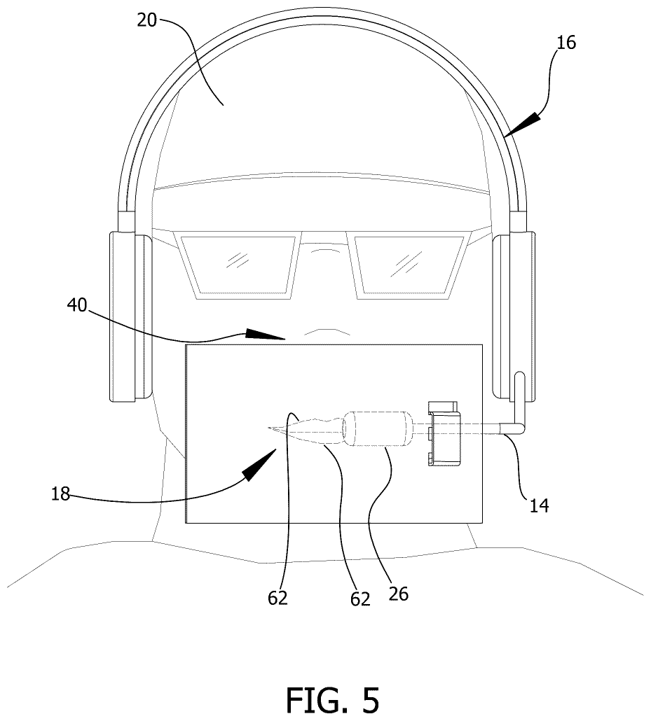

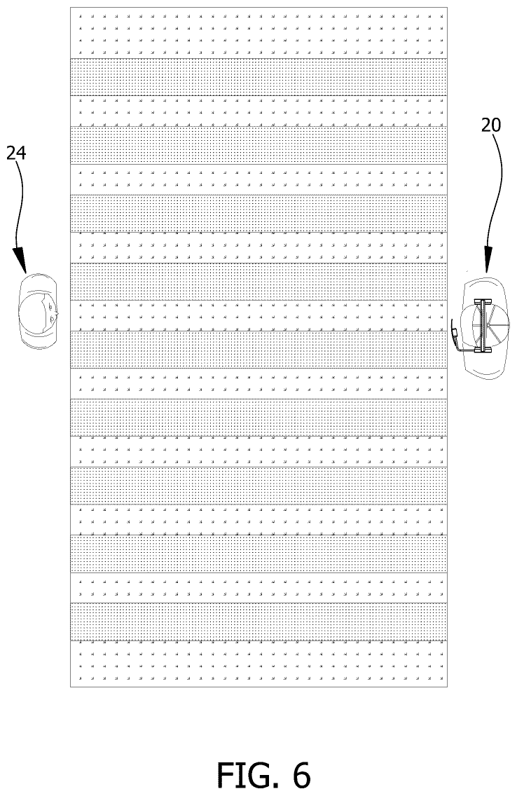

With reference now to the drawings, and in particular to FIGS. 1 through 6 thereof, a new shield device embodying the principles and concepts of an embodiment of the disclosure and generally designated by the reference numeral 10 will be described.

As best illustrated in FIGS. 1 through 6, the microphone mounted shield device 10 generally comprises a shield 12 that is mountable to a microphone arm 14 of a headset 16 such that the shield 12 is positioned in front of a mouth 18 of a user 20 when the user 20 is wearing the headset 16. The shield 12 has a plurality of perpendicularly oriented outer edges 22 such that the shield 12 has a rectangular shape thereby enabling the shield 12 to completely conceal the user's mouth 18. Furthermore, the shield 12 is comprised of an opaque material, including but not being limited to plastic or metal, thereby enabling the shield 12 to inhibit light from passing through the shield 12. In this way the shield 12 inhibits an observer 24 from being capable of perceiving the user's mouth 18 when the user 20 is speaking into a microphone 26 that is mounted to the microphone arm 14 for enhancing privacy with respect to the words the user 20 is speaking. The user 20 may be a coach of a sports team, such as an American football team for example, and the observer 24 may be a coach of an opposing sports team that has an interest in being able to perceive the coach's mouth to determine plays that the coach is calling.

The shield 12 has a front surface 28 and a back surface 30 and each of the plurality of outer edges 22 of the shield 12 extends between the front surface 28 and the back surface 30. Additionally, the plurality of outer edges 22 includes a top edge 32 and a bottom edge 34 and a first lateral edge 36 and a second lateral edge 38. The shield 12 is curved between the first lateral edge 36 and the second lateral edge 38 thereby enabling the shield 12 to conform to curvature of the microphone arm 14 when the shield 12 is mounted to the microphone arm 14. In this way the shield 12 can curve around the user's face 40 when the user 20 is wearing the headset 16 thereby enhancing the ability of the shield 12 to conceal the user's mouth 18. Furthermore, the shield 12 may have a width ranging between approximately 15.0 cm and 20.0 cm and a height ranging between approximately 7.5 cm and 10.0 cm.

A plurality of slots 42 each extends through the front surface 28 and the back surface 30 of the shield 12. The plurality of slots 42 is evenly spaced apart from each other and is distributed along a line extending between the top edge 32 and the bottom edge 34 of the shield 12. Furthermore, each of the plurality of slots 42 is elongated along an axis which extends between the first lateral edge 36 and the second lateral edge 38 of the shield 12. Each of the plurality of slots 42 is positioned closer to the second lateral edge 38 than the first lateral edge 36 of the shield 12.

A strap 48 is removably mountable to the shield 12 thereby enabling the strap 48 to be extended around the microphone arm 14 of the headset 16 for securing the shield 12 to the microphone arm 14. The strap 48 is extendable through a respective pair of the plurality of slots 42 such that the strap 48 is oriented to extend along the line which extends between the top edge 32 and the bottom edge 34 of the shield 12. The strap 48 has a primary end 50 and a secondary end 52 and the strap 48 is elongated between the primary end 50 and the secondary end 52. Additionally, the strap 48 has a first surface 54 and a second surface 56 each extending between the primary end 50 and the secondary end 52.

A first coupler 58 is attached to the first surface 54 of the strap 48 at a point is located adjacent to the primary end 50 of the strap 48. A second coupler 60 is attached to the second surface 56 of the strap 48 at a point is located adjacent to the second of the strap 48. Furthermore, the first coupler 58 is releasably matable to the second coupler 60 thereby enabling the strap 48 to form a closed loop for retaining the strap 48 around the microphone arm 14. Each of the first coupler 58 and the second coupler 60 may comprise a hook and loop fastener or other type of multiple use, releasable fastener.

In use, the shield 12 is positioned on the microphone arm 14 of the headset 16 such that the microphone 26 is approximately centrally located on the back surface 30 of the shield 12. The strap 48 is extended through the respective pair of the slots 42, depending on the user's 20 preference for the location of the strap 48 on the shield 12, and the strap 48 is extended around the microphone arm 14. Additionally, the first coupler 58 is mated to the second coupler 60 for securing the strap 48 around the microphone arm 14. In this way the shield 12 is positioned over the user's mouth 18 when the user 20 is wearing the headset 16 thereby concealing the user's mouth 18 from the observer 24. Thus, the user 20 can speak into the microphone 26 without the fear of the observer 24 being capable of perceiving the user's mouth 18 and potentially reading the user's lips 62 while the user 20 is speaking into the microphone 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A microphone mounted shield device being configured to obscure the mouth of a user when the user is speaking into a microphone of a headset thereby inhibiting an observer from perceiving the user's lips when the user is speaking, said device comprising:
a shield being mountable to a microphone arm of a headset wherein said shield is configured to be positioned in front of a user's mouth when the user is wearing said headset, said shield having plurality of perpendicularly oriented outer edges such that said shield has a rectangular shape wherein said shield is configured to completely conceal the user's mouth, said shield being comprised of an opaque material wherein said shield is configured to inhibit light from passing through said shield thereby inhibiting an observer from being capable of perceiving the user's mouth when the user is speaking into a microphone which is mounted to said microphone arm for enhancing privacy with respect to the words the user is speaking; and
a strap being removably mountable to said shield thereby enabling said strap to be extended around said microphone arm of said headset for securing said shield to said microphone arm.

2. The device according to claim 1, wherein:
said shield has a front surface and a back surface;
each of said plurality of outer edges of said shield extends between said front surface and said back surface;
said plurality of outer edges includes a top edge and a bottom edge and a first lateral edge and a second lateral edge;
said shield is curved between said first lateral edge and said second lateral edge thereby enabling said shield to conform to curvature of said microphone arm when said shield is mounted to said microphone arm;
said shield has a plurality of slots each extending through said front surface and said back surface of said shield;
said plurality of slots is evenly spaced apart from each other and is distributed along a line extending between said top edge and said bottom edge of said shield;
each of said plurality of slots is elongated along an axis extending between said first lateral edge and said second lateral edge of said shield; and
each of said plurality of slots is positioned closer to said second lateral edge than said first lateral edge of said shield.

3. The device according to claim 2, wherein said strap is extendable through a respective pair of said plurality of slots such that said strap is oriented to extend along said line which extends between said top edge and said bottom edge of said shield.

4. The device according to claim 1, wherein:
said strap has a primary end and a secondary end;
said strap is elongated between said primary end and said secondary end;
said strap has a first surface and a second surface each extending between said primary end and said secondary end;
said device includes a first coupler being attached to said first surface of said strap at a point being located adjacent to said primary end of said strap;
said device includes a second coupler being attached to said second surface of said strap at a point being located adjacent to said second of said strap; and
said first coupler is releasably matable to said second coupler thereby enabling said strap to form a closed loop for retaining said strap around said microphone arm.

5. A microphone mounted shield device being configured to obscure the mouth of a user when the user is speaking into a microphone of a headset thereby inhibiting an observer from perceiving the user's lips when the user is speaking, said device comprising:
a shield being mountable to a microphone arm of a headset wherein said shield is configured to be positioned in front of a user's mouth when the user is wearing said headset, said shield having plurality of perpendicularly oriented outer edges such that said shield has a rectangular shape wherein said shield is configured to completely conceal the user's mouth, said shield being comprised of an opaque material wherein said shield is configured to inhibit light from passing through said shield thereby inhibiting an observer from being capable of perceiving the user's mouth when the user is speaking into a microphone which is mounted to said microphone arm for enhancing privacy with respect to the words the user is speaking, said shield having a front surface and a back surface, each of said plurality of outer edges of said shield extending between said front surface and said back surface, said plurality of outer edges including a top edge and a bottom edge and a first lateral edge and a second lateral edge, said shield being curved between said first lateral edge and said second lateral edge thereby enabling said shield to conform to curvature of said microphone arm when said shield is mounted to said microphone arm, said shield has a plurality of slots each extending through said front surface and said back surface of said shield, said plurality of slots being evenly spaced apart from each other and being distributed along a line extending between said top edge and said bottom edge of said shield, each of said plurality of slots being elongated along an axis extending between said first lateral edge and said second lateral edge of said shield, each of said plurality of slots being positioned closer to said second lateral edge than said first lateral edge of said shield;
a strap being removably mountable to said shield thereby enabling said strap to be extended around said microphone arm of said headset for securing said shield to said microphone arm, said strap being extendable through a respective pair of said plurality of slots such that said strap is oriented to extend along said line which extends between said top edge and said bottom edge of said shield, said strap having a primary end and a secondary end, said strap being elongated between said primary end and said secondary end, said strap having a first surface and a second surface each extending between said primary end and said secondary end;
a first coupler being attached to said first surface of said strap at a point being located adjacent to said primary end of said strap; and
a second coupler being attached to said second surface of said strap at a point being located adjacent to said second of said strap, said first coupler being releasably matable to said second coupler thereby enabling said strap to form a closed loop for retaining said strap around said microphone arm.

6. A microphone mounted shield system being configured to obscure the mouth of a user when the user is speaking into a microphone of a headset thereby inhibiting an observer from perceiving the user's lips when the user is speaking, said device comprising:
a headset having a microphone arm and a microphone being attached to said microphone arm wherein said microphone arm is configured to extend in front of a mouth of a user when the user is wearing said headset thereby enabling the user to speak into said microphone;
a shield being mountable to a microphone arm of a headset wherein said shield is configured to be positioned in front of a user's mouth when the user is wearing said headset, said shield having plurality of perpendicularly oriented outer edges such that said shield has a rectangular shape wherein said shield is configured to completely conceal the user's mouth, said shield being comprised of an opaque material wherein said shield is configured to inhibit light from passing through said shield thereby inhibiting an observer from being capable of perceiving the user's mouth when the user is speaking into a microphone which is mounted to said microphone arm for enhancing privacy with respect to the words the user is speaking, said shield having a front surface and a back surface, each of said plurality of outer edges of said shield extending between said front surface and said back surface, said plurality of outer edges including a top edge and a bottom edge and a first lateral edge and a second lateral edge, said shield being curved between said first lateral edge and said second lateral edge thereby enabling said shield to conform to curvature of said microphone arm when said shield is mounted to said microphone arm, said shield has a plurality of slots each extending through said front surface and said back surface of said shield, said plurality of slots being evenly spaced apart from each other and being distributed along a line extending between said top edge and said bottom edge of said shield, each of said plurality of slots being elongated along an axis extending between said first lateral edge and said second lateral edge of said shield, each of said plurality of slots being positioned closer to said second lateral edge than said first lateral edge of said shield;
a strap being removably mountable to said shield thereby enabling said strap to be extended around said microphone arm of said headset for securing said shield to said microphone arm, said strap being extendable through a respective pair of said plurality of slots such that said strap is oriented to extend along said line which extends between said top edge and said bottom edge of said shield, said strap having a primary end and a secondary end, said strap being elongated between said primary end and said secondary end, said strap having a first surface and a second surface each extending between said primary end and said secondary end;
a first coupler being attached to said first surface of said strap at a point being located adjacent to said primary end of said strap; and
a second coupler being attached to said second surface of said strap at a point being located adjacent to said second of said strap, said first coupler being releasably matable to said second coupler thereby enabling said strap to form a closed loop for retaining said strap around said microphone arm.
